(19) United States
(12) Patent Application Publication
(10) Pub. No.: US 2008/0004916 A1
(43) Pub. Date: Jan. 3, 2008

(54) Promoter artist matching

(76) Inventor: Panos A. Panay, Watertown, MA (US)

Correspondence Address: HOLLAND & KNIGHT LLP, 10 ST. JAMES AVENUE, 11th Floor, BOSTON, MA, 02116-3889, US

(21) Appl. No.: 11/476,247

(22) Filed: Jun. 28, 2006

(51) Int. Cl. G06Q 10/00

(52) U.S. Cl. 705/5

(57) ABSTRACT

A computer-implemented method includes, in server system residing in a network of interconnected computer systems, managing booking of a user to a promoter event with a series of graphical user interfaces (GUIs) displayed in conjunction with a promoter account. A booking application enables promoters to generate and manage their booking of artists from within their web site account. The booking application provides flexibility, ease and automation to help promoters cut out the difficulties of booking by keeping contact and correspondence with artists, managing schedule conflict and maintaining their booking calendar all in one place.

### BACKGROUND

The present invention relates to matching, and more particularly to promoter artist matching.

Employers often post employment positions on the World Wide Web (WWW). These positions often include a brief job description, including job responsibilities and minimum requirements. Potential employees can view the posted positions, and if interested, send a resume by mail, facsimile or electronic mail.

Job searches often post their resumes on the WWW, which often include a statement of goals in obtaining suitable employment. Potential employers can view the posted resumes, and if interested, contact the prospective employee.

### SUMMARY

The present invention provides methods and apparatus, including computer program products, for promoter artist matching.

In one aspect, the invention features a method including, in server system residing in a network of interconnected computer systems, managing booking of a user to a promoter event with a series of graphical user interfaces (GUIs) displayed in conjunction with a promoter account.

In embodiments, a first GUI can include an electronic press kit (EPK) electronic mail (email) window including a list of actions, the actions selected from the group consisting of view notes, move to favorites, move to trash, move to folder, set status standby, set status not selected, set status selected printable EPK, submission information, and email artist. The EPK can include user attributes selected from the group consisting of a picture, a genre indication, contact information, a biography, audio clips, video clips, other photos, a set list, a basic requirements, including a PDF rider or a stage plot, a calendar and a reference web site. The stage plot can include a user diagram indicating the way that instruments and microphones can be arranged on a stage.

A second GUI can include universal resource locator (URLs) links selected from the group consisting of my EPK inbox, my opportunities, promoter resources, frequently asked questions (FAQs), my payments, open a drop box, community, edit profile, visits tracker, search artists and my bookings.

A third GUI can include a booking details display, the booking details display including items selected from the group consisting of artist, event, venue, date information, time information, offer expiration information, comments and send now/later information.

A fourth GUI can include a booking summary display listing all promoter account bookings, each listing including a date, event, artist, color-coded status and actions menu. The color-coded status can be indicative of an action selected from the group consisting of not sent, pending artist confirmation, confirmed, artist declined, artist canceled and promoter canceled.

A fifth GUI can include a user account display including universal resource locator (URLs) links selected from the group consisting of edit my EPK, view my EPK, edit profile, subscription information, promote my EPK, manage credit cards, promoter drop box, email my EPK now, my bookings, community, special offers, gift certificates and site credits.

A sixth GUI can include a user bookings display including actions and URLs selected from the group consisting of date, event/venue, promoter and status.

A seventh GUI can include a promoter booking calendar enabling display of one or more booked artists customizable by a promoter. The seventh GUI further can include a get hypertext markup language (HTML) code option. The get HTML code option can include selecting code to embed in the promoter booking calendar. The get HTML code option can include selected code to cause the promoter booking calendar to pop-up.

In another aspect, the invention features a method including, in a server system residing in a network of interconnected computers, maintaining promoter profile data residing in a storage medium, the promoter profile data comprising an opportunity listing that includes promotional and informational data about an opportunity for which a promoter is seeking client submissions.

In embodiments, the promotional and informational data is selected from a list consisting of a logo, photos of an opportunity, a detailed opportunity description, a submission fee that the promoter charges for each submission of an electronic press kit (EPK) that comes in and which clients are asked to pay using cash, check, money order, credit card, site credits or other electronic payment, prior to submission. The promotional and informational data can include a questionnaire that a client is required to complete prior to submission of an EPK.

In another aspect, the invention features a method including, in a server system residing in a network of interconnected computers, maintaining client profile data residing in storage medium, the client profile data comprising user attributes selected from the group consisting of a picture, a genre indication, contact information, a biography, audio clips, video clips, other photos, a set list, a basic requirements list referred to as a stage plot, a calendar and a reference web site.

In embodiments, the stage plot can include a user diagram indicating instrument and microphone stage layout.

The invention can be implemented to realize one or more of the following advantages.

The system includes a drop box wizard that enables music promoters to subscribe to a web site and to generate their own “drop box” listing, i.e., an opportunity listing that contains promotional and informational data about one or more opportunities for which they are seeking artist submissions. A drop box can include a logo, photos of events, event descriptions, and so forth. A drop box can be moderated and approved by a web site administrator.

The system includes one or more electronic press kits (EPKs). An artist can submit his/her EPK to one or more promoter's drop boxes or email their EPK in a markup language format, such as hypertext markup language (HTML), to an owner of the drop box. When the promoter gets an EPK through email they have the ability to “save” this EPK in their account “Favorites,” or they can create an account and save the EPK in their account “Favorites” if the promoter does not already have an account.

A drop box can include organizational tabs, such as “Home,” “Open Opportunities,” “Favorites,” and “My Submissions.”

The system includes an EPK enhancement. The EPK enhancement can include additional MP3 samples, video, high resolution photos, other basic information about an artist and a “stage plot.” A stage plot is a diagram that artists use to indicate the way that instruments, microphones, and so forth, are arranged on a stage.

The system can route artist EPK submissions into promoter folders based on a custom questionnaire.

The system can include a booking application that enables promoters to generate and manage their booking of artists from within their web site account. The booking application provides flexibility, ease and automation to help promoters cut out the difficulties of booking by keeping contact and correspondence with artists, managing schedule conflict and maintaining their booking calendar all in one place.

One implementation of the invention provides all of the above advantages.

Other features and advantages of the invention are apparent from the following description, and from the claims.

### BRIEF DESCRIPTION OF THE DRAWINGS

FIG. 1 is a block diagram of an exemplary system.

FIG. 2 is a block diagram of an exemplary graphical user interface (GUI).

FIG. 3 is a block diagram of an exemplary GUI.

FIG. 4 is a flow diagram.

FIG. 5 is a block diagram of an exemplary GUI.

FIG. 6 is a block diagram of an exemplary GUI.

FIG. 7 is a block diagram of an exemplary GUI.

FIG. 8 is a block diagram of an exemplary GUI.

FIG. 9 is a block diagram of an exemplary GUI.

FIG. 10 is a block diagram of an exemplary GUI.

FIG. 11 is a block diagram of an exemplary GUI.

FIG. 12 is a block diagram of an exemplary GUI.

FIG. 13 is a block diagram of an exemplary GUI.

FIG. 14 is a block diagram of an exemplary GUI.

FIG. 15 is a block diagram of an exemplary GUI.

Like reference numbers and designations in the various drawings indicate like elements.

### DETAILED DESCRIPTION

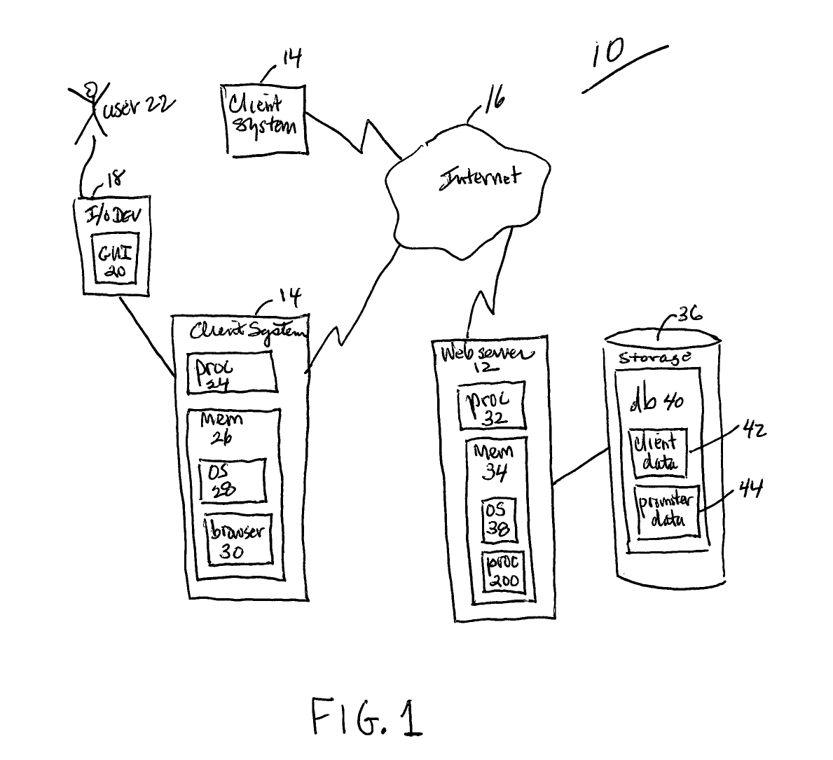

As shown in FIG. 1, an exemplary system 10 includes a web server 12 linked to one or more client systems 14 through a network 16, such as the Internet. Each of the client systems 14 can include an input/output (I/O) device 18 for display of a graphical user interface (GUI) 20 to a user 22. Each of the client systems 14 includes a processor 24 and memory 26. Memory 26 includes an operating system (OS) 28, such as Linux, Windows® or Palm®, and a browser application program 30, such as FireFox™, Mozilla™, Netscape Communicator® or Internet Explorer®. The browser application program 30 provides a way for the user 22 to view and interact with information residing in the web server 12.

The web server 12 includes a processor 32, memory 34 and storage device 36. Memory 34 includes an operating system (OS) 38, such as Linux, Windows® or Palm®, and a client promoter process 200, described below.

The storage device 36 includes a database 40. The database 40 includes client data 42 and promoter data 44. Client data 42 includes client profiles generally referred to as electronic press kits (EPKs). Each EPK represents an easy-to-use, web-based alternative to bulky, expensive physical press kits. Each EPK contains basic promotional information about a client's act such as music, photos, press reviews, bio, performance calendar, and so forth. Unlike a physical press kit, a client can build, update, and send out his/her EPK at any time as much as needed. More particularly, each EPK can include an initial picture, a genre indication, contact information, a biography, audio clips, video clips, other photos, a set list, a basic requirements list, a calendar, a reference web site, and so forth.

Promoter data 44 includes promoter profiles and promoter information generally referred to as drop boxes. Each drop box is connected to an opportunity listing that includes promotional and informational data about an opportunity for which a promoter is seeking client (i.e., artist) or song submissions. More particularly, a drop box can include a logo, photos of an event, a detailed event description, and/or a submission fee that the promoter charges for each submission of an EPK that comes in and which clients (i.e., artists) are asked to pay using cash, money order, credit card, check, site credit prior to submitting to the particular drop box. The drop box can also include a questionnaire that a client is required to complete prior to submission of an EPK to the drop box. Each of the drop boxes, once generated by the promoters, can be viewed by each of the clients.

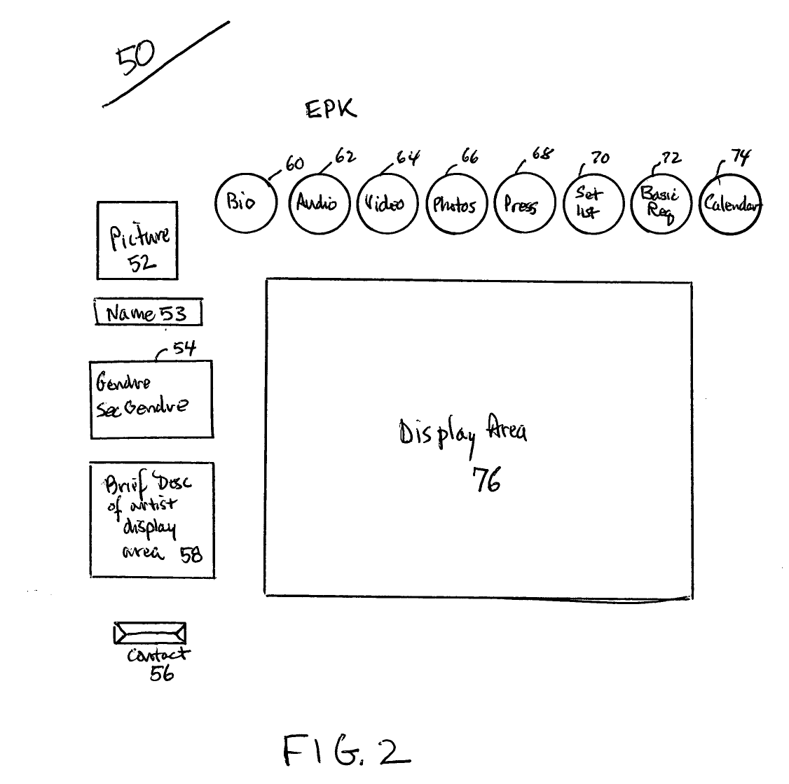

As shown in FIG. 2, a GUI 50 representing an exemplary EPK can include a primary picture 52, artist name 53, a genre box 54, a contact box 56 and a brief artist description display area 58. The GUI 50 includes buttons including bio 60, audio 62, video 64, photos 66, press information 68, set list 70, basic requirements 72 and calendar 74. Clicking on any of the buttons 60-74 causes a corresponding respective display in a display area 76. For example, clicking of the bio button 60 causes biographical information of the artist to be displayed in the display area 76. Clicking on the audio button 62 causes links to audio clips of the artist 53 to displayed on the display area 76. Clicking on an audio clip in the display area 76 causes execution of the audio clip, such as an MPEG-1 Audio Layer-3 (MP3) file.

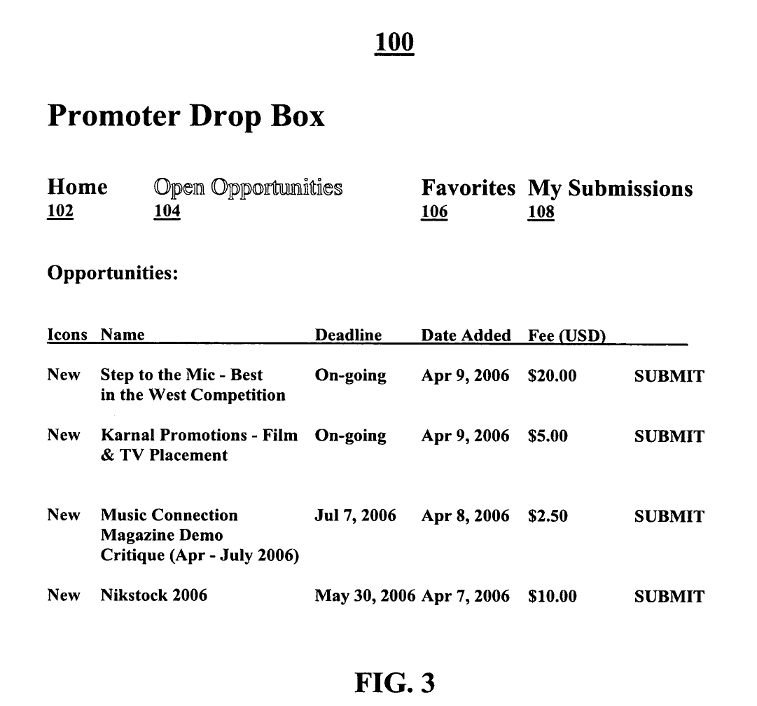

As shown in FIG. 3, a GUI 100 representing an exemplary drop box includes four tabs, i.e., Home 102, Open Opportunities 104, Favorites 106, and My Submissions 108.

Selecting the “home” tab 102 causes a display of snapshot views of the most popular, most recently added, and nearest upcoming deadlines for open opportunities separated by the three major opportunity categories, i.e., live opportunities, song contests/competitions, and publicity. This display can also include primary featured opportunities in all three categories that includes a logo.

Selecting the “open opportunities” tab 104 the user can save an opportunity to favorites, perform an advanced search, save an advanced search, view details about an opportunity and customize how the page looks.

The “favorites” tab 106 enables a convenient place for artists to view all of the opportunities they've marked as “favorite.” Artists can save notes along with their favorites, and they can also elect to receive an email reminder about the opportunity on a date of their choosing.

The “my submissions” tab 108 enables artist members to see all the submissions they've made as well as view incomplete submissions. If an artist begins to submit to an opportunity and then either abandons the submission process, or clicks “Finish Later” on a custom questions page, the submission is saved to their incomplete submissions. An email reminder can be sent to artists three days before a submission deadline, one day before if the deadline is within three days, and no email is sent if the deadline is less than 24 hours away, or the opportunity has no deadline. As the opportunity is open, the artist can pick up the submission wherever they left off from their submissions tab 108.

In operation, the user 22 on one of the client systems 14 calls a web page from the web server 12 and is prompted to enter a username and password. The user 22 can initiate a new account or log on to an existing account. The user 22 can create/add/edit/delete their EPK. The user 22 can view a summary of promoter opportunities and select any one particular opportunity, i.e., promoter drop box, for detailed viewing. The user 12 can submit their EPK or submit songs to any one or more of promoter drop boxes. In turn, a promoter can view EPKs submitted into their account (e.g., drop box), including all the basic promotional information about a client's act such as music, photos, press reviews, bio, performance calendar, and so forth.

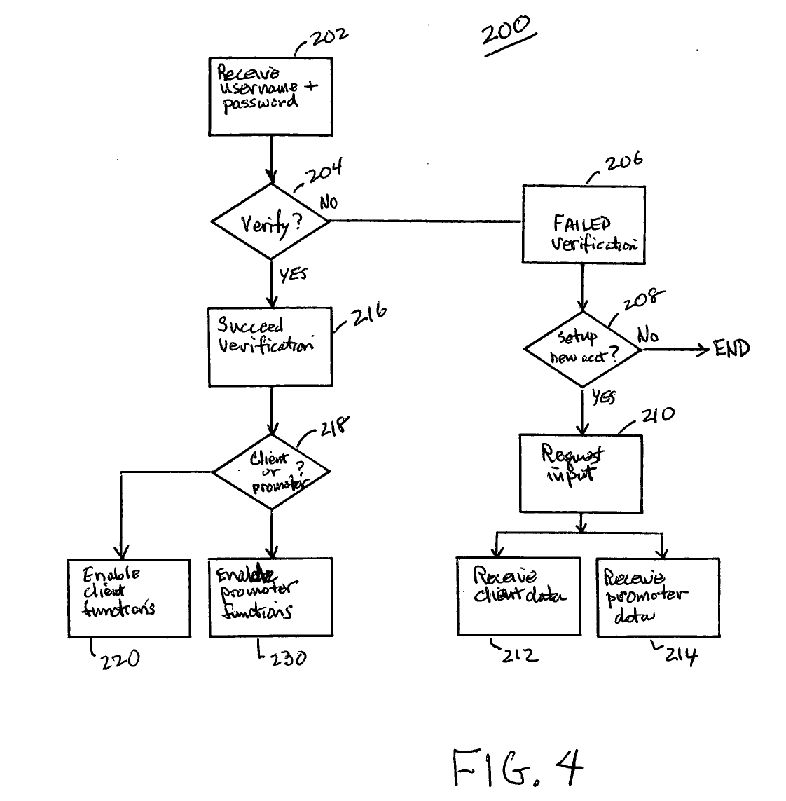

As shown in FIG. 4, the client promoter process 200 includes receiving (202) from a client system a username and password. The client promoter process 200 verifies (204) the username and password and if the verification (204) fails (206), process 200 requests (208) whether the new user would like to set up a new account. If the new user wishes to set up an account, process 200 requests (210) input of a username, password, and whether the user is a client or a promoter. If the user is a client, process 200 interactively requests and receives (212) data from the client in order to generate a user profile and an electronic press kit (EPK). As described above, the EPK can include a lead picture, a genre indication, contact information, a biography, audio clips, video clips, other photos, a set list, a basic requirements list, a calendar, a reference web site, and so forth.

If the user is a new promoter, process 200 interactively requests and receives (214) data from the new promoter in order to generate a “drop box” listing, i.e., an opportunity listing that contains promotional and informational data about one or more events for which they are seeking artist submissions. A drop box can include a logo, photos of events, event descriptions, and so forth.

If the verification (204) succeeds (216), process 200 determines (218) whether the user is a client or promoter. If the user is a client, process 200 enables (220) client functions providing the client to terminate their account, add/modify/delete their EPK, browse promoter drop boxes, send their EPK, save one or more specific promoter drop boxes as a favorite, and so forth.

If the user is a promoter, process 200 enables (230) promoter functions providing the promoter to terminate their account, add/modify/delete to their opportunity drop box, browse client EPKs, contact artists, specify what type of EPKs they wish to receive, save one or more specific EPKs as a favorite, execute a booking application process 300, and so forth.

A booking application process 300 enables promoters to create and manage their booking of artists from within their promoter account through a number of graphical user interfaces (GUIs). The booking application process 300 provides flexibility, ease and automation to help promoters cut out the difficulties of booking by keeping contact and correspondence with artists, managing schedule conflict and maintaining their booking calendar all in one place.

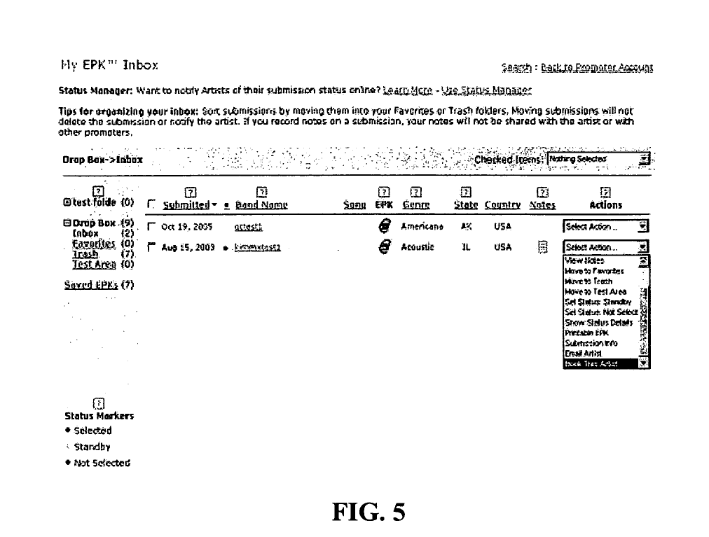

As shown in FIG. 5, from within a promoter account, the promoter has two options for how they can book an artist. The first option is to use the Actions menu in the EPK Inbox.

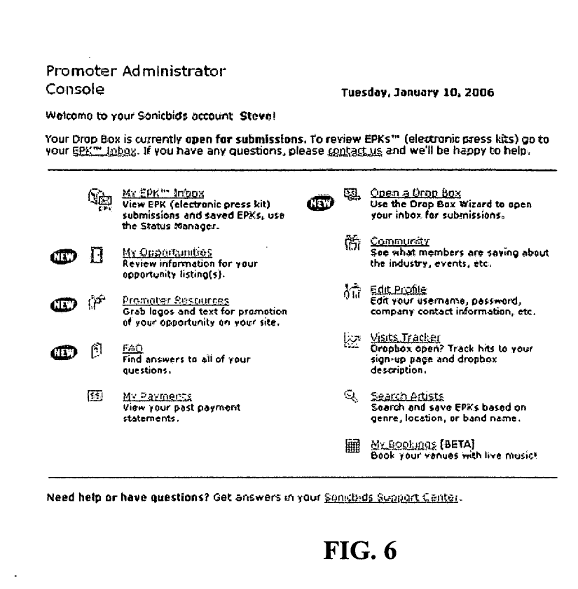

As shown in FIG. 6, a promoter can also get started by going to the “My Bookings” link on their account homepage, called the Promoter Administrator Console. The link to “My Bookings” is at the bottom of the right-hand column.

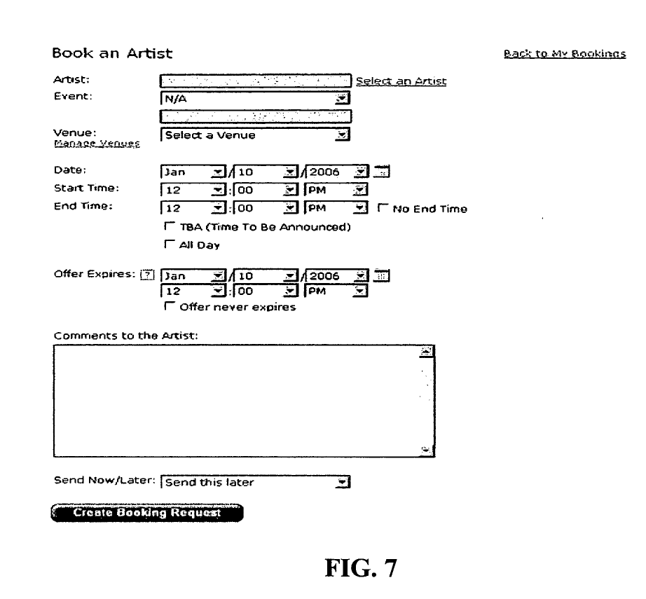

As shown in FIG. 7, whichever way a promoter starts a booking, they will be brought to a booking details page where they'll add info including artist event, venue, date, time, expiration date for the offer, comments to the artist and an option to send now or send later.

If a promoter uses the Actions menu to book an artist already in their Inbox, the artist field is pre-populated on the booking details page. If the promoter begins from the “My Bookings” link, they need to select an artist from either their Inbox or by a site-wide search of web server 12.

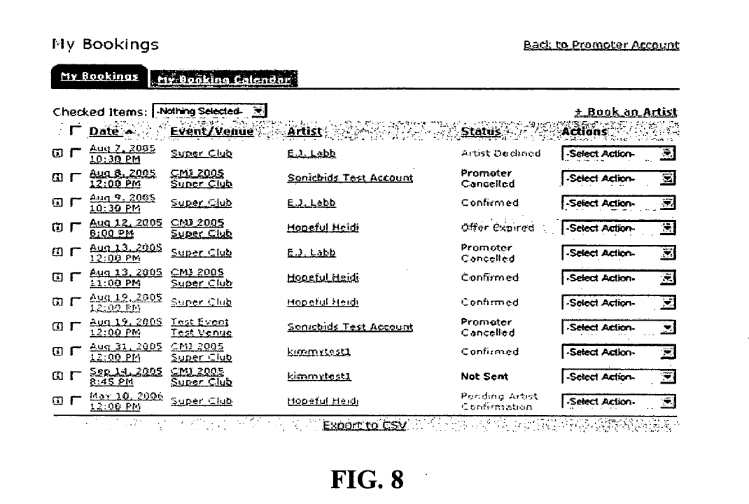

As shown in FIG. 8, before the promoter completes a request, they have the option of whether they want to send the request now or send it later. When the promoter clicks “Create Booking Request” process 300 confirms that it has been created and added to your “My Bookings” page. If they decide to send it now, it will say “Pending Artist Confirmation,” whereas if they opt to send it later, it will be listed as “Not Sent.”

The “My Bookings” page lists all bookings, i.e., date, event, artist, color-coded status (Not Sent, Pending Artist Confirmation, Confirmed, Artist Declined, Artist Cancelled or Promoter Cancelled) and an Actions menu.

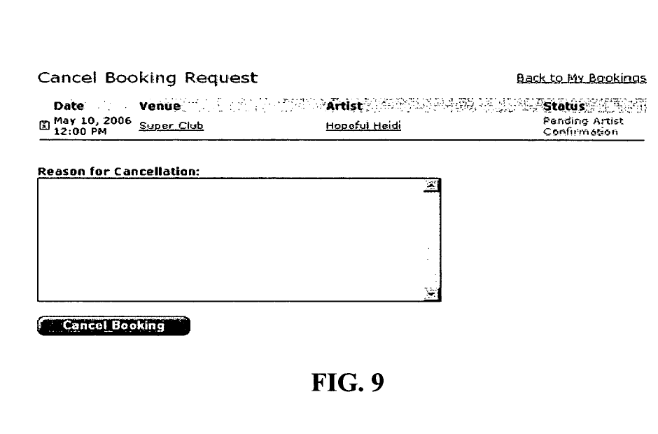

As shown in FIG. 9, once a booking has been sent, promoters have an option to edit or cancel the booking, using the Actions menu on the promoter's “My Bookings” page. The promoter has a place to enter a reason for cancellation so that the artist is informed. The artist gets an email upon cancellation, and the status of the booking changes to “Promoter Cancelled.”

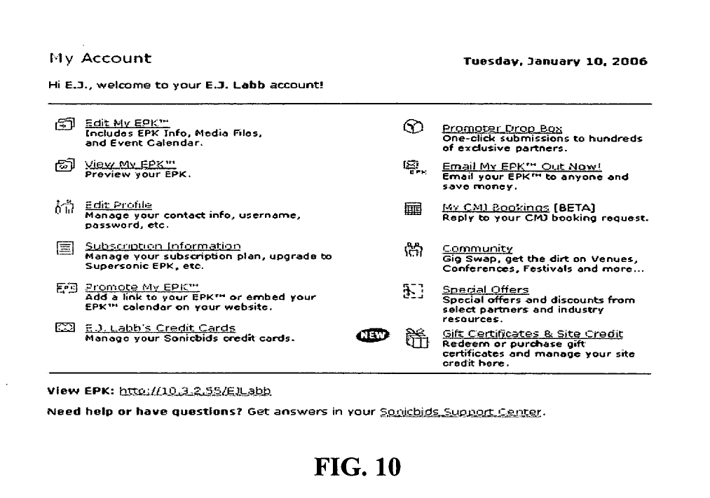

As shown in FIG. 10, once a promoter sends a booking request, the artist receives a new booking request email telling them to login to their account. In their account there will be a bold link that says “My Bookings (1 new).” This link is found in the middle of the right-hand column.

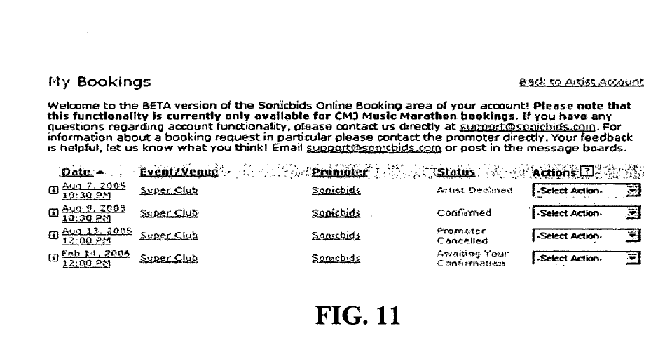

As shown in FIG. 11, once the artist clicks the booking link, they are taken to their “My Bookings” page where they can see the details of the Promoter's offer with the status as “Awaiting Your Confirmation.” They'll have a number of different options—and once they either Accept or Decline, this will be updated in the promoter's account.

If the artist would like to contact the promoter prior to accepting or declining an offer, the artist can contact the promoter directly by selecting the “Email Promoter” option in the Actions menu of their “My Bookings Page.”

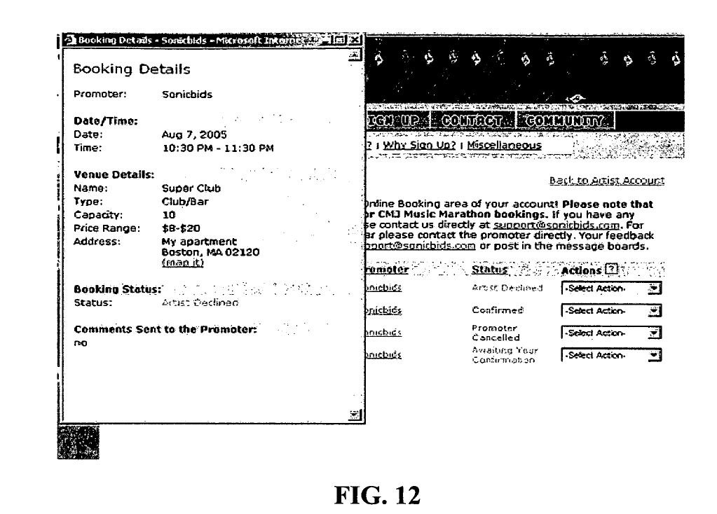

As shown in FIG. 12, if the artist would like to see the details of a particular booking, they can do so by either selecting the “View Details” option of the “My Bookings Page”—or by clicking on the date, event/venue, or promoter in their list of bookings, for the booking they wish to view. Any of these actions presents the artist with a pop-up window of their booking details.

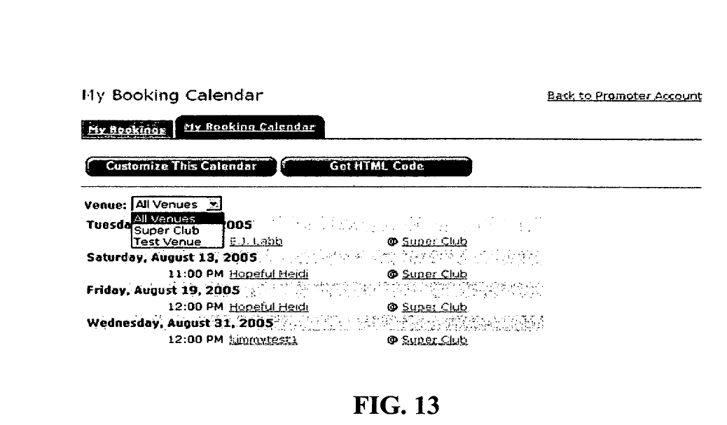

As shown in FIG. 13, the booking application process 300 has a flexible calendar feature that enables the promoter to display the artists that they've booked in the custom view of their choice. From the promoter's “My Bookings” page, there is a tab “My Booking Calendar,” which is how the promoter accesses this feature. The default view of this page is to list all artist bookings for all venues. The promoter also has the option to list bookings for a particular venue by selecting a specific venue from the venue drop-down menu at the top of the page.

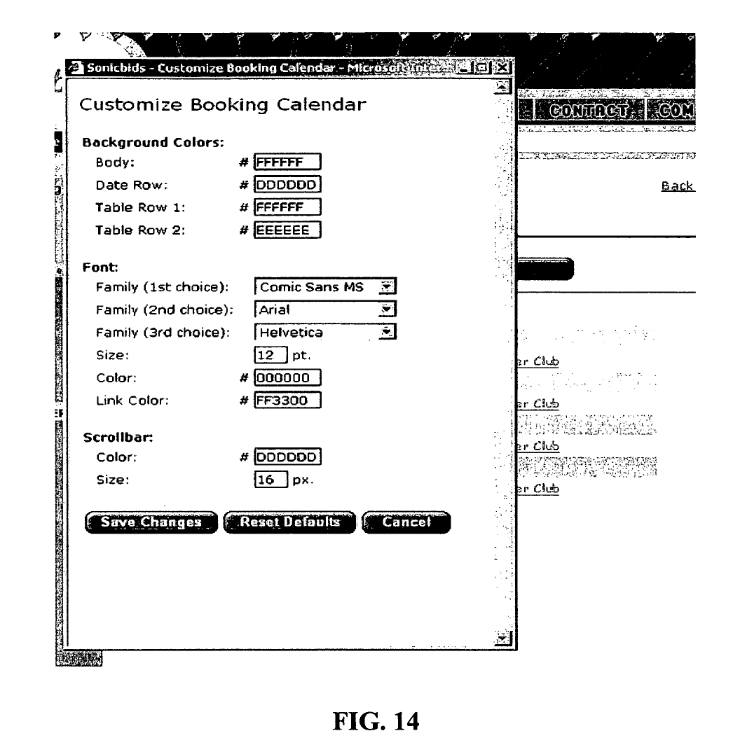

As shown in FIG. 14, if the promoter wishes to customize the look and feel of the calendar, they can use the “Customize This Calendar” option. Customization options include background colors, font style, size and color and scroll bar color and size. Just by changing a few settings, the promoter can match the look and feel of the calendar to that of their website.

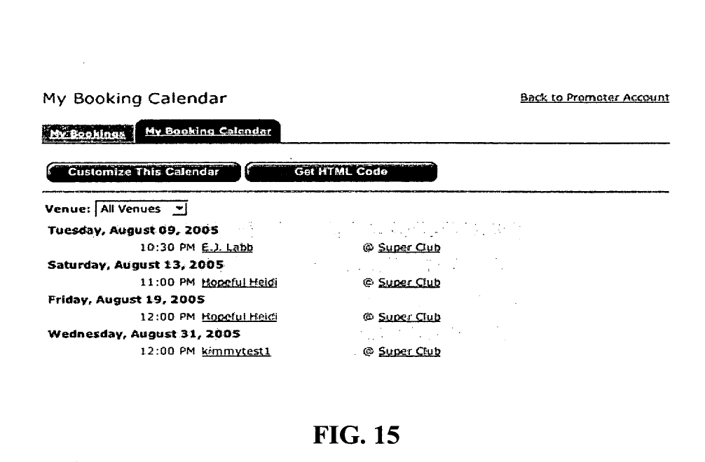

As shown in FIG. 15, there is also an option to “Get HTML Code” so once the promoter has customized the calendar as they wish, they can select code to either embed the calendar on their site or pop up the calendar from their site. All they have to do is select which way they'd like to display the calendar and copy and paste the code into the source of their site. This is a powerful feature for promoters to use to not only post their schedule but to provide instant access to information about the artists they have booked because the HTML code includes links to artist EPKs.

Embodiments of the invention can be implemented in digital electronic circuitry, or in computer hardware, firmware, software, or in combinations of them. Embodiments of the invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of embodiments of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

It is to be understood that the foregoing description is intended to illustrate and not to limit the scope of the invention, which is defined by the scope of the appended claims. Other embodiments are within the scope of the following claims.

What is claimed is:

1. A computer-implemented method comprising:
in a server system residing in a network of interconnected computer systems, managing booking of a user to a promoter event with a series of graphical user interfaces (GUIs) displayed in conjunction with a promoter account.

2. The computer-implemented method of claim 1 in which a first GUI comprises an electronic press kit (EPK) electronic mail (email) window including a list of actions, the actions selected from the group consisting of: view notes, move to favorites, move to trash, move to folder, set status standby, set status selected, set status not selected, set status selected printable EPK, submission information and email artist.

3. The computer-implemented method of claim 2 in which the EPK comprises:
user attributes selected from the group consisting of: a picture, a genre indication, contact information, a biography, audio clips, video clips, other photos, a set list, basic requirements including a PDF rider or a stage plot, a calendar and a reference web site.

4. The computer-implemented method of claim 3 in which the stage plot comprises a user diagram indicating the way that instruments and microphones are arranged on a stage.

5. The computer-implemented method of claim 1 in which a second GUI comprises universal resource locator (URLs) links selected from the group consisting of: my EPK inbox, my opportunities, promoter resources, frequently asked questions (FAQs), my payments, open a drop box, community, edit profile, visits tracker, search artists and my bookings.

6. The computer-implemented method of claim 1 in which a third GUI comprises a booking details display, the booking details display including items selected from the group consisting of: artist, event, venue, date information, time information, offer expiration information, comments and send now/later information.

7. The computer-implemented method of claim 1 in which a fourth GUI comprises a booking summary display listing all promoter account bookings, each listing comprising a date, event, artist, color-coded status and actions menu.

8. The computer-implemented method of claim 7 in which the color-coded status is indicative of an action selected from the group consisting of: not sent, pending artist confirmation, confirmed, artist declined, artist canceled and promoter canceled.

9. The computer-implemented method of claim 1 in which a fifth GUI comprises a user account display including universal resource locator (URLs) links selected from the group consisting of: edit my EPK, view my EPK, edit profile, subscription information, promote my EPK, manage credit cards, promoter drop box, email my EPK now, my bookings, community, special offers, gift certificates and site credits.

10. The computer-implemented method of claim 1 in which a sixth GUI comprises a user bookings display including actions and URLs selected from the group consisting of: date, event/venue, promoter and status.

11. The computer-implemented method of claim 1 in which a seventh GUI comprises a promoter booking calendar enabling display of one or more booked artists customizable by a promoter.

12. The computer-implemented method of claim 11 in which the seventh GUI further comprises a get hypertext markup language (HTML) code option.

13. The computer-implemented method of claim 12 in which the get HTML code option comprises selecting code to embed in the promoter booking calendar.

14. The computer-implemented method of claim 12 in which the get HTML code option comprises selected code to cause the promoter booking calendar to pop-up.

15. A computer-implemented method comprising:
in a server system residing in a network of interconnected computers, maintaining promoter profile data residing in storage medium, the promoter profile data comprising an opportunity listing that includes promotional and informational data about an opportunity for which a promoter is seeking client submissions.

16. The computer-implemented method of claim 15 in which the promotional and informational data is selected from a list consisting of: a logo, photos of an opportunity, a detailed opportunity description, a submission fee that the promoter charges for each submission of an electronic press kit (EPK) and which clients are asked to pay using cash, check, money order, credit card, site credit or other electronic payment, prior to submission.

17. The computer-implemented method of claim 16 in which the promotional and informational data further comprises a questionnaire that a client is required to complete prior to submission of an EPK.

18. A computer-implemented method comprising:
in a server system residing in a network of interconnected computers, maintaining client profile data residing in storage medium, the client profile data comprising user attributes selected from the group consisting of a picture, a genre indication, contact information, a biography, audio clips, video clips, other photos, a set list, a basic requirements list referred to as a stage plot, a calendar and a reference web site.

19. The computer-implemented method of claim 18 in which the stage plot comprises a user diagram indicating instrument and microphone stage layout.
